(19) United States
(12) Patent Application Publication
(10) Pub. No.: US 2006/0195889 A1
(43) Pub. Date: Aug. 31, 2006

(54) Method for configuring and controlling access of a computing device based on location

(76) Inventors: Gerald W. Pfleging, Batavia, IL (US); George Paul Wilkin, Bolingbrook, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/070,124

(22) Filed: Feb. 28, 2005

(51) Int. Cl. H04L 9/32

(52) U.S. Cl. 726/4

(57) ABSTRACT

The present invention provides a method for configuring and controlling access of a computing device based upon the location of the computing device. The communication system determines the location of a computing device. If the location of the computing device is within a valid location area, the computing device is granted a dynamic IP address. The communication system retrieves previous login information for the computing device. The communication system determines if the computing device is configured for access to a network. If previous login information for the computing device is found, the communication system uses the retrieved login information to login the computing device to the network. The previous login information is then stored.

### FIELD OF THE INVENTION

The present invention relates generally to computing devices, and more particularly to a method for configuring and controlling access of a computing device to a network based upon the location of the computing device.

### BACKGROUND OF THE INVENTION

Computing devices are used for an ever-expanding number of applications. The processing capabilities have continued to increase while the size of computers has decreased. This has allowed computing devices to connect to a broadband network, such as the Internet, while at different location. Each location, however, has different access and configuration parameters necessary for the computing device to access the network.

When a user wants to connect to a wireless network they must configure the device to talk to an associated access point. A typical user often has two access points they connect to, a work access point and a home access point. Most of the current wireless card configuration software packages allow a user to store multiple connection point configurations that they might normally use.

With the growing number of locations and connection choices that are available to users, it could get very difficult for a user to continually have to reconfigure their system to connect to each new network. Wireless networks, such as WiFi networks, are becoming more prevalent due to their fairly easy installation, dropping price point and the freedom of movement the technology allows.

However with this new technology many new dangers arise for the users of this technology. This type of network is much easier to tap into due to the fact there is not a need for a physical connection in order to connect. There is also a problem of rogue installations or installation by individuals that have little understanding of the included security abilities and liabilities. Often users install the wireless access point units without changing the basic IP and password information from the manufacturer. Most users don't configure the security settings on the devices they purchase for fear that they will not understand what they mean or that they are worried they will forget how to get into the systems once they are set up. Market forces drive suppliers to try to expand the signal as far as possible to allow a user maximum range. This leads to the signal be propagated outside of its intended boundaries of a home or office area.

Location finding technology, such as GPS, is maturing to the point that it will be commonplace in most computing devices, either embedded within the computing device or via a cellular device with the technology.

Therefore, a need exists for a method for configuring and controlling access of a computing device to a network based upon the location of the computing device.

### BRIEF SUMMARY OF THE INVENTION

The present invention provides a method of configuring a computing device for access to a wireless network based on the location of the computing device. The communication network determines the location of the computing device and the computing device is connected to the communication network.

The network device queries the access point using general stored data entries in the configuration files of the operating system. The communication network determines if the computing device is configured for the communication network using the stored configuration information. If the stored configuration information is correct, the communication network logs in the computing device to the communication network.

If the computing device is not configured for the communication network, the communication network retrieves the stored login information for the computing device. If no previous login information is found, the communication network allows the user to configure the computing device manually.

If the communication network finds the previous login information for the computing device, the communication network uses the retrieved information to login the computing device to the communication network.

The communication network saves the login information. Once a user has authenticated the computing device for a certain location, their successful configuration parameters are preferably stored in an encrypted manner on the computing device for use on their next access to a resource in that location. The data stored is associated with the current GPS location of the computing device.

In an exemplary embodiment of the present invention, the information entered by a user is stored and marked with GPS location information as a key relation. In a further exemplary embodiment, the settings are pre-programmed into the computing device. This allows access to the communication network in a predetermined area, such as a corporate communication network. The computing device then logs in to the communication network using the configuration settings.

In a further exemplary embodiment, the present invention provides a method for controlling access of a computing device to a network based upon the location of the computing device. The communication network determines the location of the computing device.

The computing device connects to the communication network. When a client attempts to connect to a wireless access point several frames of information are sent to and from the access point with information to allow the user to authenticate and then be configured. During this message sequence, security defenses are executed.

The communication network determines if dynamic access is enabled for the computing device. If not, the communication network determines if the computing device is within a valid location area. If the access point resides within the calculated area of coverage defined by the user during set-up, access to the communication network is allowed to continue. If the access point does not reside within the calculated area of coverage defined by the user during set-up, access to the communication network is blocked, preferably by being added to the blocked MAC address list that is available by default in almost all current implementations.

During the initial configuration of the system, a user preferably is prompted to take their computing device and go to the locations in which they will be using the computing device. In an alternate exemplary embodiment, the user of the computing device would be prompted to enter address data as part of the registration process. The data is then used to set a center point as a base location and allows for an approximate circle around the center point.

If dynamic access is enabled, the computing device applies to the communication network for a dynamic IP address. When the DHCP server receives the clients request it inspects the message for the presence of GPS parameters. If they are not present the server will not offer an address that will allow it to access the network.

If the initial message contains the required coordinates, the DHCP server preferably searches saved location information and makes a determination of the allow ability of the location and make a determination on whether to offer an address. If an address is offered an address is sent to the client and the normal automated process can continue.

The communication network determines if the computing device is within a valid location area. If the computing device is not located within a valid location area, the communication network denies the application for a dynamic IP address.

If the computing device is within a valid location area, the communication network grants a dynamic IP address to the computing device. The computing device then performs a traditional network login using the retrieved configuration parameters.

### BRIEF DESCRIPTION OF THE SEVERAL VIEWS OF THE DRAWINGS

FIG. 1 depicts a location area and a plurality of computing devices in accordance with an exemplary embodiment of the present invention.

FIG. 2 depicts a flowchart of a method for configuring a computing device based upon the location of the computing device in accordance with an exemplary embodiment of the present invention.

FIG. 3 depicts a flowchart of a method for controlling access of a computing device to a network based upon the location of the computing device in accordance with an exemplary embodiment of the present invention.

### DETAILED DESCRIPTION OF THE INVENTION

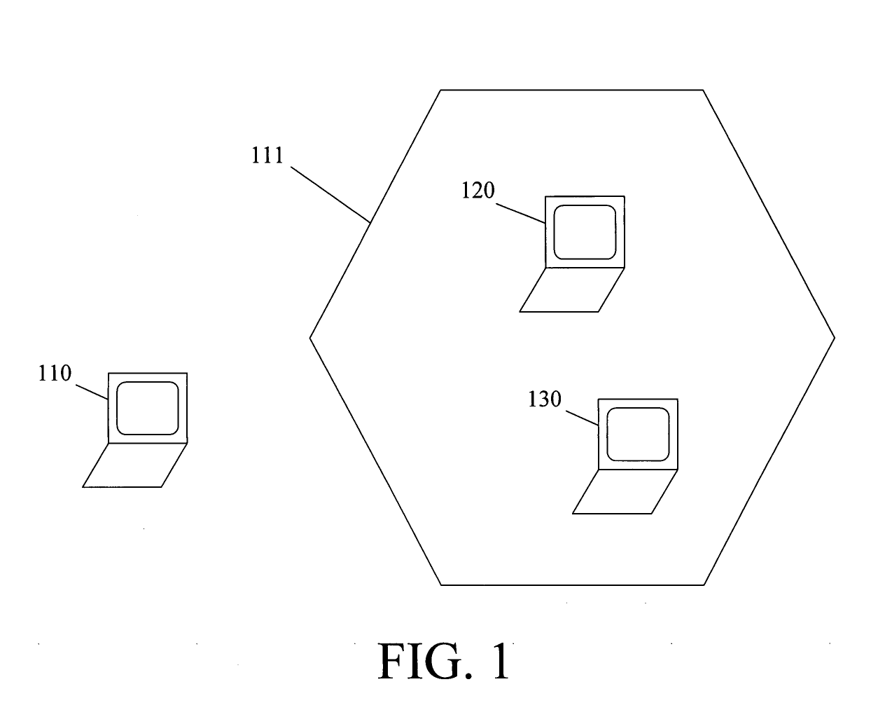

FIG. 1 depicts a location area 111, a first computing device 110, a second computing device 120, and a third computing device 130 in accordance with an exemplary embodiment of the present invention.

Location area 111 is a geographic area defined by geographic boundaries. Location area 111 can be defined by any geographic coordinates. Further, location area 111 can be defined by geographic coordinates and altitude. The location area can be limited to a house, a building, an office, a lab, or any other location that an owner of a computing device would want to limit the operability of the computing device to. Location area 111 is typically limited by the range in transmission of a transmitter located within location area 111.

Computing device 110 is preferably a portable computer. Computing device 110 can be a computer, a Personal Digital Assistant (PDA), a mobile phone, or any other electronic device. As depicted in FIG. 1, computing device 110 is not located within location area 111.

Computing devices 120 and 130 are depicted as portable computers that are located within location area 111. Computing devices 120 and 130 can be a computer, a Personal Digital Assistant (PDA), a mobile phone, or any other electronic device. Computing devices 120 and 130 each include an indication that the computing device is subject to a location restriction and also the coordinates of the location area.

As depicted in FIG. 1, computing device 110 is located outside of location area 111 and computing devices 120 and 130 are located within location area 111.

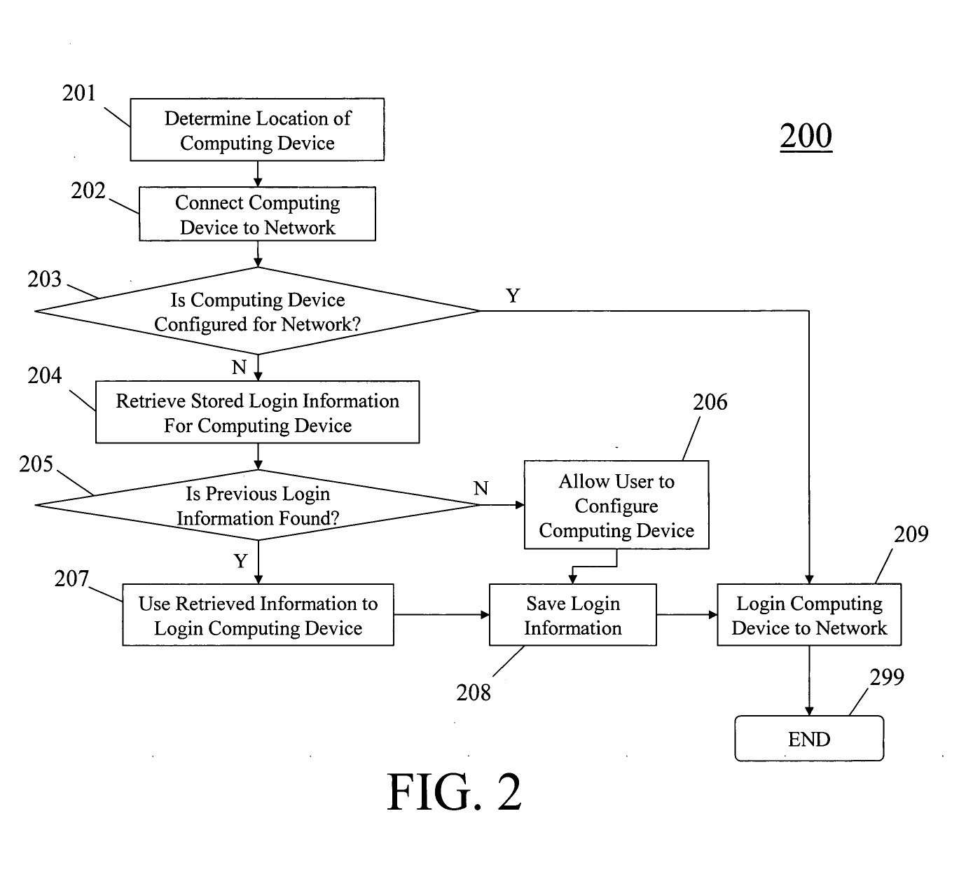

FIG. 2 depicts a flowchart 200 of a method for configuring a computing device based upon the location of the computing device in accordance with an exemplary embodiment of the present invention. The present invention allows for an automated or assisted login to a communication network using the current location of a computing device.

The communication network determines (201) the location of the computing device. In an exemplary embodiment, the computing device determines the location utilizing a Global Positioning System (GPS). In a further exemplary embodiment, the computing device determines its location utilizing a triangulation technique, such as the method being used for cellular E911 services.

The computing device is connected (202) to a communication network, preferably a wireless communication network. The computing device detects a transmission signal from the communication network.

The network device queries the access point using general stored data entries in the configuration files of the operating system. The communication network determines (203) if the computing device is configured for the communication network using the stored configuration information. If the data is correct, the communication network logs in (209) the computing device to the communication network. The process then ends (299).

If the computing device is not configured for the communication network as determined at step 203, the communication network retrieves (204) the stored login information for the computing device.

The communication network determines (205) if the previous login information for the computing device has been found. When a user enters a location and turns on their device, the device will search the users' stored information to see if the device has used a network in the current location plus some radius value to determine if the configuration is already known.

If no previous login information is found in step 205, the communication network allows (206) the user to configure the computing device manually. Even if there is no previous login information, the user of the computing device, or a system administrator, can enter configuration parameters that allows the computing device to access a communication network. If there is no known configuration the user is given the option to enter the configuration, which is typically posted in the physical location that the user has entered. If there is a conflict in settings the user would be presented with a choice of which network they would like to be connected to. This allows the use of sub-networks within a large corporate or government installation.

If the communication network finds the previous login information for the computing device as determined at step 205, the communication network uses (207) the retrieved information to login the computing device to the communication network.

The location information will be monitored and used to trigger automated or assisted logins. When a user enters a location that they have previously used a unique combination to access a resource a login sequence (which could be automated with no interaction, or be an interactive process (using a secure ID)) can be triggered to let the user can access to the associated network. In the case where the user should have access to a network over a large area or campus a radius setting can be used to a marked location to allow the login to be used anywhere in a large installation.

The communication network saves (208) the login information. Once a user has authenticated the computing device for a certain location, their successful configuration parameters are preferably stored in an encrypted manner on the computing device for use on their next access to a resource in that location. The data stored is associated with the current GPS location of the computing device.

In an exemplary embodiment of the present invention, the information entered by a user is stored and marked with GPS location information as a key relation. The communication system may be more advanced and download a listing, from a central server or set of servers, once it connects. This could provide all of the locations where this configuration information will work, such as at all locations of a restaurant or other business. If that list can be captured, the list is added to the list of visited systems and will be available if the user later enters one of those locations with the same computing device.

In a further exemplary embodiment, the settings are pre-programmed into the computing device. This allows access to the communication network in a predetermined area, such as a corporate communication network.

The computing device then logs in (209) to the communication network using the configuration settings. The process then ends (299).

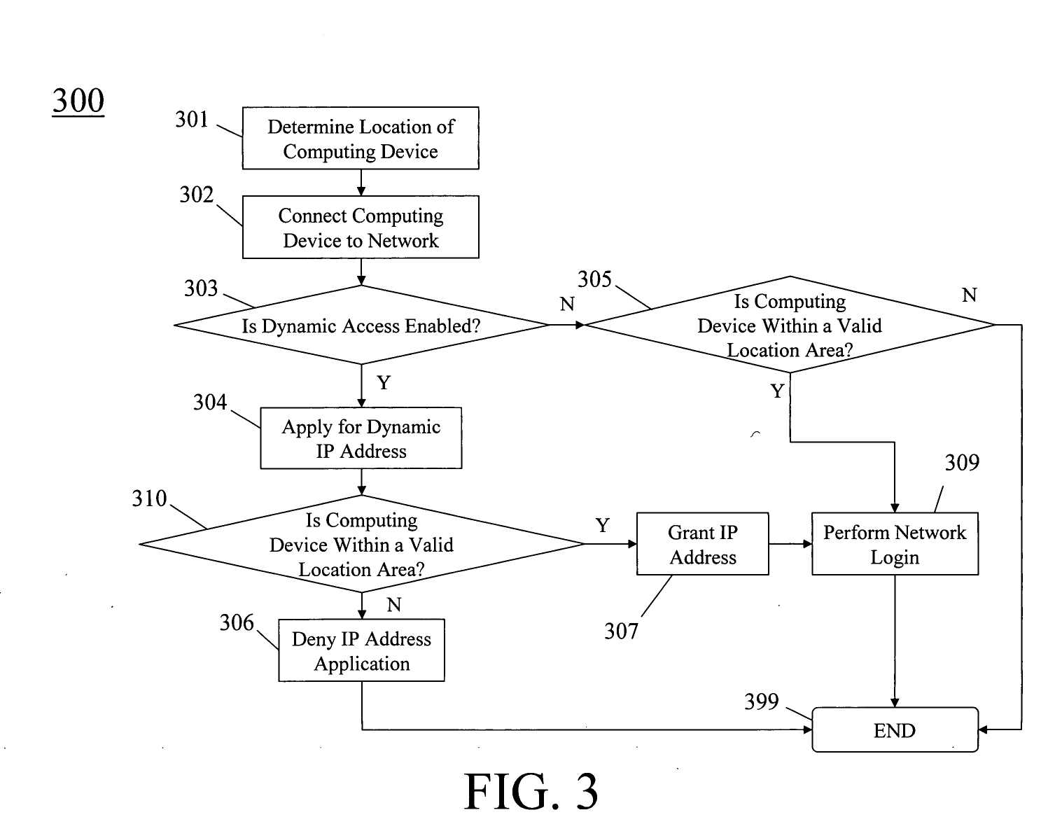

FIG. 3 depicts a flowchart 300 of a method for controlling access of a computing device to a network based upon the location of the computing device in accordance with an exemplary embodiment of the present invention. Once an access point in a communication network has location information stored, the communication network is in the position to defend itself from outside clients or systems using the location information that was gathered in the set-up phase.

The communication network determines (301) the location of the computing device. In an exemplary embodiment, the computing device determines the location utilizing a Global Positioning System (GPS). In a further exemplary embodiment, the computing device determines its location utilizing a triangulation technique, such as the method being used for cellular E911 services.

The computing device connects (302) to the communication network. When a client attempts to connect to a wireless access point several frames of information are sent to the access point and back with information to allow the user to authenticate and then be configured. During this message sequence, security defenses are executed. In an exemplary embodiment, the communication network uses a message type of Management with a sub-type of Authentication with a newly defined message. For example, the messages may be defined by ANSI/IEEE 1999 Std for 802.11.

The communication network determines (303) if dynamic access is enabled for the computing device. If not, the communication network determines (305) if the computing device is within a valid location area. The message preferably includes the GPS location information of the current computing device attempting to connect to the access point. If the access point resides within the calculated area of coverage defined by the user during set-up, access to the communication network is allowed to continue. If the access point does not reside within the calculated area of coverage defined by the user during set-up, access to the communication network is blocked, preferably by being added to the blocked MAC address list that is available by default in almost all current implementations.

If there is a need for a more advanced security, an exemplary embodiment of the present invention can be enhanced to unlock previously locked systems. In an extreme case, any routing or firewall devices in the network can be configured to always block access to any clients not explicitly stated in their configuration tables.

During the initial configuration of the system, a user would preferably be prompted to take their computing device and go to the locations in which they will be using the computing device. For example, the user may set the computing device to initial configuration mode and configure the computing device at home, work, and other public places that the user expects to use the computing device to connect to a communication network. The computing device preferably receives provided location capture markers from each location in the communication network using data from the GPS locator in the computing device.

In an alternate exemplary embodiment, the user of the computing device would be prompted to enter address data as part of the registration process. The data is then used to set a center point as a base location and allows for an approximate circle around the center point. In an exemplary embodiment, the radius of the circle around the center point is in the range of ten to fifty feet.

This process is preferably seamless to the end user. The GPS information that is needed to be sent will be configured as a requirement of the underlying operating system that is requesting the DHCP access.

If dynamic access is enabled as determined at step 303, the computing device applies (304) to the communication network for a dynamic IP address. When the DHCP server receives the clients request it inspects the message for the presence of GPS parameters. If they are not present the server will not offer a DHCPOFFER message back to the requester and the client will not get an address that will allow it to access the network.

If the initial message contains the required coordinates, the DHCP server preferably searches saved location information and makes a determination of the allow ability of the location and make a determination on whether to offer an address. If an address is offered a DHCPOFFER message will be sent to the client and the normal automated process can continue.

The communication network determines (310) if the computing device is within a valid location area. This process is preferably the same as that performed in step 305.

If the computing device is not located within a valid location area, the communication network denies (306) the application for a dynamic IP address, and the process ends (399).

If the computing device is within a valid location area as determined at step 310, the communication network grants (307) a dynamic IP address to the computing device. Upon a successful DHCPOFFER message, an automatic reconfiguration of network firewalls, routers, and DNS and Authentication servers can preferably be performed by adding the MAC address of the computing device requesting access to the proper locations to allow access to the computing device.

This exemplary embodiment also handles the possibility that the person attempting to gain access has some knowledge of the network topology and may be able to make intelligent choices in choosing a static address to attempt to gain access to the communication network. The lease time in this embodiment is preferably set to a small value to make the computing device re-authenticate its position in order to make sure that the computing device has not moved outside of the pre-approved location area. This is not of great concern in a wired network as the user would have to physically disconnect and reconnect the computing device to the network, thereby triggering a new DHCP process. When the lease time expires, the communication system preferably locks down all required systems again, denying access to the computing device.

The computing device then performs (309) a traditional network login using the retrieved configuration parameters. The process then ends (399).

While this invention has been described in terms of certain examples thereof, it is not intended that it be limited to the above description, but rather only to the extent set forth in the claims that follow.

We claim:

1. A method for configuring a computing device based upon the location of the computing device, the method comprising:
determining the location of a computing device;
determining if the computing device is configured for access to a network;
retrieving previous login information for the computing device;
determining if the previous login information was found;
if the previous login information was found, using the retrieved login information to login the computing device to the network; and
storing the previous login information.

2. A method for configuring a computing device based upon the location of the computing device in accordance with claim 1, wherein the step of determining the location of a computing device comprises determining the location of a computing device utilizing a Global Positioning System (GPS).

3. A method for configuring a computing device based upon the location of the computing device in accordance with claim 1, wherein the step of determining the location of a computing device comprises determining the location of a computing device utilizing a triangulation technique.

4. A method for configuring a computing device based upon the location of the computing device in accordance with claim 1, the method further comprising the step of manually configuring the computing device if the previous login information is not found.

5. A method for configuring a computing device based upon the location of the computing device in accordance with claim 1, wherein the step of determining if the computing device is configured for access to a network comprises querying an access point using stored data entries in the computing device.

6. A method for configuring a computing device based upon the location of the computing device in accordance with claim 1, wherein the step of using the retrieved login information comprises utilizing a secure ID to login the computing device to the network.

7. A method for configuring a computing device based upon the location of the computing device in accordance with claim 1, wherein the step of storing the previous login information comprises storing the previous login information utilizing encryption.

8. A method for configuring a computing device based upon the location of the computing device in accordance with claim 1, wherein the step of storing the previous login information comprises associating the previous login information with the location of the computing device.

9. A method for configuring a computing device based upon the location of the computing device in accordance with claim 1, wherein the step of storing the previous login information comprises storing the previous login information indexed by the location of the computing device.

10. A method for controlling access of a computing device to a network based upon the location of the computing device, the method comprising:
determining the location of a computing device;
connecting the computing device to a network;
determining if dynamic access is enabled for the computing device;
applying for a dynamic IP address for the computing device; and
if the location of the computing device is within a valid location area, granting the dynamic IP address to the computing device.

11. A method for controlling access of a computing device to a network based upon the location of the computing device in accordance with claim 10, wherein the step of connecting the computing device to a network comprises sending a plurality of frames of information between the computing device and the network.

12. A method for controlling access of a computing device to a network based upon the location of the computing device in accordance with claim 11, the method further comprising the step of executing security procedures.

13. A method for controlling access of a computing device to a network based upon the location of the computing device in accordance with claim 10, wherein the step of granting the dynamic IP address to the computing device comprises utilizing an authentication technique.

14. A method for controlling access of a computing device to a network based upon the location of the computing device in accordance with claim 10, further comprising the step of denying the dynamic IP address for the computing device if the location of the computing device is not within a valid location area.

15. A method for controlling access of a computing device to a network based upon the location of the computing device in accordance with claim 14, further comprising the step of adding the computing device to a blocked MAC address list.

16. A method for controlling access of a computing device to a network based upon the location of the computing device in accordance with claim 10, wherein the step of granting the dynamic IP address to the computing device comprises inspecting the application for a dynamic IP address for GPS parameters.

17. A method for controlling access of a computing device to a network based upon the location of the computing device in accordance with claim 10, the method further comprising, if the location of the computing device is within a valid location area, reconfiguring firewalls, routers, and authentication servers of the network.

18. A method for controlling access of a computing device to a network based upon the location of the computing device in accordance with claim 17, wherein the step of reconfiguring comprises adding the MAC address of the computing device to the network.

19. A method for controlling access of a computing device to a network based upon the location of the computing device in accordance with claim 10, wherein the step of granting the dynamic IP address to the computing device comprises granting the dynamic IP address to the computing device comprises for a predetermined amount of time.

20. A method for controlling access of a computing device to a network based upon the location of the computing device in accordance with claim 19, further comprising denying access to the network by the computing device after the predetermined amount of time.
